(19) United States
(12) Patent Application Publication
(10) Pub. No.: US 2014/0316873 A1
(43) Pub. Date: Oct. 23, 2014

(54) Apparatus, system and methods to issue a prize to a user of a credit account based on user purchase activities

(71) Applicant: Randy D. Sines, Spokane, WA (US)

(72) Inventor: Randy D. Sines, Spokane, WA (US)

(73) Assignee: CodeCard, Inc.

(21) Appl. No.: 13/986,334

(22) Filed: Apr. 22, 2013

(51) Int. Cl. G06Q 30/02

(52) U.S. Cl. CPC G06Q 30/0222; G06Q 30/0215
USPC 705/14.17

(57) ABSTRACT

An apparatus for issuing a prize to a user includes a prize activity host computer including a prize issuing program, a seller computer, and a user purchase input device. A purchase authorization request is transmitted from the seller computer to the prize activity host computer. User information (including user identification and user account information, obtained from the user purchase input device) is sent to the prize activity host computer. When the prize activity host computer confirms the purchase request, the prize activity host computer also determines when a prize is to be issued to the user, and thereafter issues the prize to the user. The apparatus is particularly useful for issuing prizes to users based on the users' use of a credit account to make a purchase.

### TECHNICAL FIELD

The present disclosure pertains to apparatus, systems and methods for generating prize opportunities for users of a credit account when using the credit account to make a purchase, and issuing prizes to the users.

### BACKGROUND

It is well known for operators of credit accounts (for example, credit card companies) to offer users of the credit account a reward for using the account. For example, Visa, Inc. (with headquarters in San Francisco, Calif.) is an issuer of credit cards. As indicated at the website http://corporate.visa.com/index.shtml (as of Dec. 29, 2012), “Visa is a global payments technology company that enables consumers, businesses, financial institutions and governments to use electronic payments instead of cash and checks.” Visa Inc. works with banks and merchants to offer credit cards to users (businesses, consumers, corporate entities, etc.). In one business model the issuing bank or merchant (vendor) offers users of the credit account rewards as an incentive to encourage the users to use the card. For example, Amazon.com, Inc. (with headquarters in Seattle, Wash.) offers users an Amazon.com Visa credit card. By using the Amazon.com Visa credit card (or the accompanying credit account) users accrue points as a reward for their use of the card (or account). The points are awarded based on the value of any purchase made. (For example, for each hundred dollars spent using the account, the user is rewarded one point.) As an added incentive for users to use the card or account to make purchases from the issuing vendor, the vendor might offer triple points for every purchase made from the issuing vendor. Points can be redeemed by applying them to future purchases (typically from the issuing vendor). In the case where the card (or account) is issued by a bank (versus a vendor), points can typically be redeemed by applying them to the customer's (user's) account. This method and system for issuing awards (or rewards) to users of credit accounts is currently in common and broad use, and thus it is difficult for credit companies to gain a competitive advantage other than by offering higher levels of awards, or awards that can be more widely applied. Therefore, what is needed is a new means to encourage users to use one particular credit account over another.

### BRIEF DESCRIPTION OF THE DRAWINGS

FIG. 1 is a front view of an exemplary prior art smart card.

FIG. 2 is a back view of an exemplary prior art smart card.

FIG. 3 is a front view of another exemplary prior art smart card.

FIG. 4 depicts a user grasping the smart card of FIG. 3 so that thumbprint information (as a verification parameter) can be obtained.

FIGS. 5A and 5B together depict a flowchart of an exemplary prize issuing program in accordance with the present disclosure.

FIG. 6 is a block diagram depicting an embodiment of a prize issuing apparatus in accordance with the present disclosure.

FIG. 7 is a block diagram depicting an embodiment of a prize issuing system in accordance with the present disclosure.

FIG. 8 is a block diagram depicting a matrix of communicated information and various communication devices, and how communication of the communicated information can be distributed among the various communication devices in accordance with the current disclosures.

### DETAILED DESCRIPTION

The readers of this document should understand that the embodiments described herein may rely on terminology and features used in any section or embodiment shown in this document and other terms readily apparent from the drawings and language common or proper therefor. This document is premised upon using one or more terms or features shown in one embodiment that may also apply to or be combined with other embodiments for similar structures, functions, features and aspects of the present disclosure and provide additional embodiments of the present disclosure.

I have developed a new method, and accompanying systems and apparatus, to encourage users to use one credit account versus another. The method (and accompanying systems and apparatus) is based on offering users of a particular credit account the opportunity to win a prize based on their use of that particular credit account to make purchases, and thereafter issuing such prizes to the users. This will make it more attractive for users to use that particular credit account (and thus the entity offering the credit account will garner more business).

While the present disclosure is particularly attractive for use with credit accounts (as explained further below), it will be understood that the methods disclosed herein (and the accompanying systems and apparatus) can also be offered by other entities (e.g., entities that host a debit account on behalf of users).

In the following disclosure the following terms will be used. A credit account is understood to be an account offered to users which provides immediate (or near immediate) payment to a vendor or other seller for a purchase by a user of the credit account, but allows deferred payment by the user of the credit account for the purchase. The entity offering a credit account to users will be referred to herein as a credit entity. A debit account is understood to be an account offered to users which provides immediate payment to a vendor or other seller for a purchase by a user of the debit account, and requires immediate payment from the user from an account under the control of the user. (A bank debit card and a cash card are examples of debit accounts.) The entity hosting or offering a debit account to users will be referred to herein as a debit entity. A user will mean any entity (e.g., an individual, a company, a government entity, etc.) who makes a purchase (or purchases) using a credit account or a debit account. Also as used herein, seller will mean any entity who provides goods and/or services to users based on purchase of the goods and/or services using a credit account or a debit account held by the user.

As indicated above, the instant disclosure provides for a credit entity or a debit entity to offer an opportunity to users of a credit account (or debit account) to win a prize based on use of the account. Since prizes will typically be funded by the offering credit entity or debit entity, the offering entity will need to fund the prizes from a prize account. (Alternative arrangements for funding and/or providing the prizes are described below.) In the case of a credit entity, such entities typically fund their activities (and generate their profits) from one or more of the following: (i) by charging users interest on accounts (and typically, on account balances that are not paid in full within a specific period of time); (ii) by charging sellers who accept payment from the credit entity a percent of any purchase paid for by the credit entity; and/or (iii) by annual dues or fees paid to the credit entity by the sellers and/or users in exchange for allowing them access to the credit services. In the case of a debit entity, such entities typically fund their activities (and generate their profits) from one or more of the following: (i) by charging users a fee for their use of the debit account (e.g., a charge of $0.50 for each use of the debit account, or perhaps a percentage of a purchase made using the debit account); and/or (ii) by charging users a charge for setting up a debit account. As can be appreciated, credit entities are much better positioned than debit entities (from a financial perspective) to offer to users the prize giving methods described herein, since prizes will typically (but not necessarily) be funded by the offering entity. It will be understood that the methods described herein (and accompanying systems an apparatus) are not limited to use only by credit entities, but also by debit entities. However, for the sake of simplifying the following discussion and description only, the embodiments will be described with respect to being offered by credit entities. Thus, when latter reference is made to a credit entity, it is understood to include a debit entity unless specifically indicated otherwise or by context of the then-current discussion.

Credit accounts and debit accounts can be accessed by users to make a purchase in a number of different ways. The most common ways will now be described. (i) By use of a physical credit card (or debit card) at the point of purchase. (A credit card and/or a debit card will be referred to generically herein as a card.) This method typically involves the seller acquiring the credit account (or debit account) number at the time of purchase from the physical card itself. This is frequently done by passing the card through a card reader (such as a magnetic swipe card reader) to read a magnetically encoded strip on the card which identifies an associated credit or debit account. (Other types of readers can also be used to obtain the account information from the card, such as an optical scanner.) While done much less frequently, the seller can acquire the account number from the physical card by writing down the account number which is presented on the card, or by passing pressure-sensitive copy paper over the card (when the account number is presented on the card in a raised relief format). Other means for a seller to acquire an account number from a physical card can include optical scanning of an optically readable code on the card, proximity scanning of an RFID chip or magnetic encoding on the card, and other known and future technologies. (ii) By providing a seller with the user's account number (credit account or debit account) when a purchase is made by the user. This method of making a purchase using a credit or debit account is most common when a user makes a purchase online (as via the internet). For example, when making a purchase using the internet, the user may be requested to provide a credit account number, a debit account number, a referral to a customer account number (which, in turn, references a credit or debit account number), or access to a payment service (such as for example, PayPal, a payment processing service owned by eBay Inc. with headquarters in San Jose, Calif.). A user's credit or debit account number can also be provided to a seller via telephonic communication, e-mail, facsimile, and/or written communication, by way of example only. (iii) A third method of payment is a hybrid method of payment, wherein the payment is made by reference to the user's account number (i.e., per the second method described above), but is verified by way of the user obtaining a verification code or number (or the like) from a smart-card (as describe below).

In general, the following description of the embodiments disclosed herein will refer to a purchase made using a physical card in order to affect the purchase as being a card-based purchase. Likewise, a purchase made by referral to an account (direct or indirect, and not using a physical card) in order to affect the purchase will be referred to herein as a being an account-based purchase. (A hybrid purchase, as described in item (iii) above, will be considered as being an account-based purchase.) Thus, for purposes of the following description, the term purchase will be understood to mean any financial transaction between a user and a seller in which a sale from a seller to a user is paid for via a credit account or a debit account held by the user (and offered by a credit entity or a debit entity).

It is known to provide credit cards, and debit cards, with one or more verification parameters in order verify that a person making a purchase using the card (and particularly in an online transaction) is in physical possession of the card. The most common of these is a verification code printed on the card itself, and which is not a part of the account number. A common version of such a verification code is the credit card identification code (or CCID), which is typically a 3-4 digit number printed on the back of the card. Thus, when a user is making an account-based purchase (e.g., by making a purchase online), the seller website may ask for the buyer (user) to enter the verification number. The purpose of a seller asking a prospective buyer to provide a verification number is to ensure that the buyer is in actual possession of the card (thus preventing potential fraud by those who have improperly obtained a credit or debit account number but who are not in actual possession of the respective card itself). However, the requirement of providing a CCID (or the like) at the time of purchase does not prevent against purchases by one who has stolen a physical card (which provides the CCID). Thus, it is now also known to provide credit (and debit) cards with active on-board systems for receiving one or more verification parameters in order to enable the card for purposes of allowing a transaction to be made with the card. A credit card and/or a debit card with an active on-board verification system will be referred to herein as a smart card. (One example of such a card is described in U.S. patent application publication number US 2008/0308627 A1 (published Dec. 8, 2008), which is hereby incorporated by reference herein in its entirety.) In one variation a smart-card can include an on-board verification system requiring a user to enter an identification (or verification) code into a keypad (or the like) into the card itself in order to authorize a specific purchase intended to be made by one in possession of the card. In this example, a user may be required to enter a personal identification number (i.e., “PIN”) into a keypad on the card in order to enable activation (and/or readability) of a magnetized (or otherwise readable) strip or image on a card. In another variation a smart-card can include an on-board verification system requiring a user to enter a biometric parameter into a biometric receiver within the card itself in order to authorize a specific purchase intended to be made by one in possession of the card. In this latter example a biometric receiver can include (without limitation) a fingerprint reader, an iris scanner, a signature recognition algorithm, etc. Thus, any input required from a user in order to enable use of a smart credit or smart debit card, or to verify the authenticity of a user of a credit or debit card, can be described as a verification parameter.

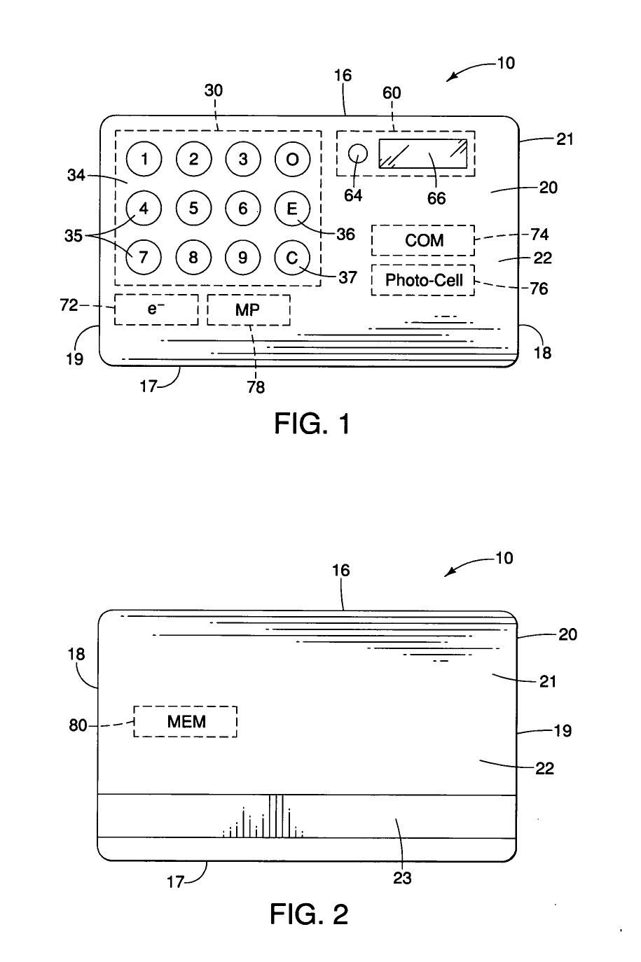

Two examples of smart cards will now be described with respect to FIGS. 1-4. With reference to FIG. 1, this figure depicts a front view of an exemplary prior art smart card 10. Referring further to FIGS. 1-4, a smart card apparatus forming a portable charge, credit, debit or similar identification card is generally indicated by the numeral 10. The card 10 can be any suitable size or shape, but is preferably of a rectangular shape and of a size similar to, or the same as, that commonly used for conventional financial cards (e.g., credit cards and debit cards). The rectangular shape of the card 10 is defined in part by a top edge 16 (first or long side edge), a bottom edge 17 (second or long side edge), a right edge 18 (first or short end edge) and a left edge 19 (second or short end edge). The card 10 has a front surface 20 and a back surface 21. Together, the edges 16, 17, 18 and 19 and the front and back surfaces 20 and 21 define in part a card body 22. The card 10 can include written, embossed, or other information on the front or back surfaces 20, 21 of the card if desired (not shown). Such information can include data which is commonly included on conventional financial cards. By way of example, this information can include such things as: the account number, the card holder's name, the date the card holder became a member (i.e., member-since data), the expiration date, logos, photographs, a security code, and/or signatures. Other information can be included or deleted from the outer surface of the card as desired or required.

Referring now to FIG. 2, the card 10 can include a magnetic stripe or strip 23 for storing encoded information. The card 10 which includes such a magnetic strip 23 can advantageously be swiped through and read by a variety of conventional magnetic swipe card readers and/or relevant portion of a card reader system.

Information or data can be stored on the card 10. For example, information or data can be encoded on the magnetic stripe 23 in accordance with any suitable data format. The current conventional magnetic stripe has an industry standard allocation of bits for various types of data and different multiple tracks. Therefore, although such information can be stored at any suitable location (e.g., track) on the magnetic strip 23, industry conventions or standards will typically apply. In one example the information is encoded in accordance with international standards so typical magnetic swipe readers can readily read the card 10. The magnetic strip 23 can be used for identification and/or for other purposes, such as amount of cash available or other information. (In addition to the storage of information on a magnetic stripe 23, smart cards can also use any other now-know or yet-to-be discovered forms of card data storage which can be used in place of and/or in addition to the magnetic stripe 23. By way of example and not by way of limitation, embodiments of the card 10 can also include a smart chip for data storage.) Further, because magnetic strips for storing encoded information, and magnetic card readers (e.g., magnetic swipe card readers) configured to read the encoded information, are well known, this document will not review the fundamental technology related to magnetic stripes and their applicable card readers. Instead, this document will describe new apparatuses and methods for utilization of this technology.

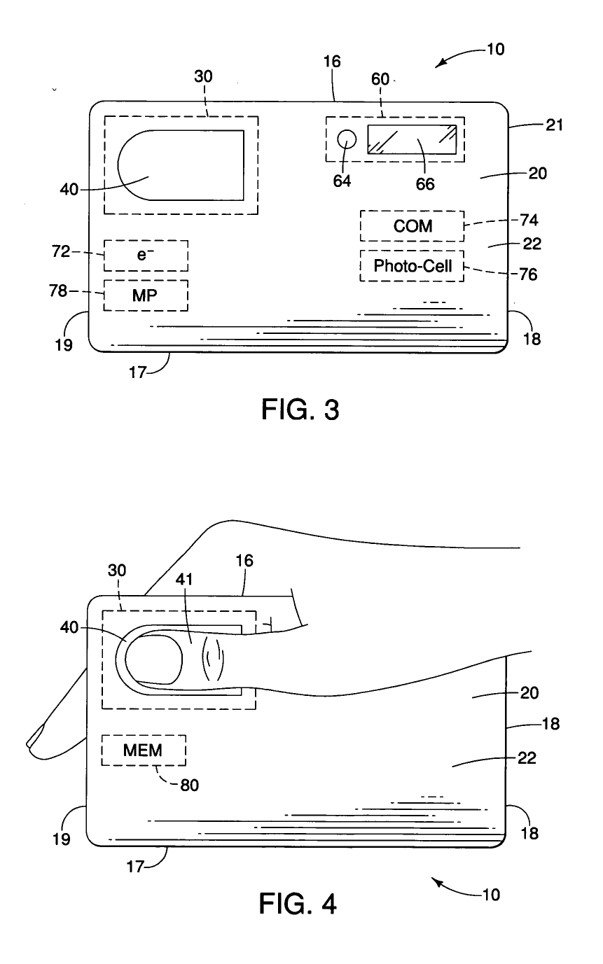

FIGS. 1 and 3 depict two smart cards 10 which include at least one detector for sensing actions, attributes or other characteristics (i.e., verification parameters) of a user. The detection of the verification parameter(s) can be accomplished using an input device 30. The input device 30 can include a device requiring manipulation (e.g., the keypad 30 of FIG. 1), or it can be a device that serves passively or actively by interrogation of the user's body to determine biological information (such as the thumbprint input device 30 of FIG. 3). The input, such as a PIN (“Personal Identification Number”), thumbprint, retinal scan, etc. can be combined with one or more other authentication fields to indicate authenticity or non-authenticity of the user. Biological information or other authentication data can be used in combination with user active input data, such as a PIN. The input device or devices are generally illustrated in FIGS. 1 and 3 as a box 30, shown in phantom lines. The input device or other detector 30 can be adapted for a user to enter verification or authentication data, and can be of various suitable designs. In addition, the input device 30 can be located at various suitable positions on the card 10 or can be attached thereto in a suitably durable fashion to allow input of the user input (verification) data.

Referring again to FIG. 1, in one implementation detector 30 comprises at least one key, such as a keypad 34 located on the front surface 20 of card 10. Keypad 34 is adapted to receive or detect user input, such as the authentication data entered by the user. Here the keypad 34 includes a plurality of numerical keys 35 which can be sequentially pressed to enter data, such as authentication data, for example, a personal identification number (PIN), or other means for verifying or authenticating the user. The required input can be dynamic and variable from use-to-use, or static and similar for each use. Keypad 34 can also include one or more function keys, such as an enter key 36 and clear key 37. The enter key 36 is to be pressed by the user once the PIN has been entered. The enter key 36 can also be configured as an authorization key, thus requesting authorization information for a purchase. Pressing the enter key 36 can cause the PIN (or other verification information) to be sent to an authorizing entity (as described below). Keypad 34 (FIG. 1) can also include a correct or clear key 37. The correct key 37 can be pressed by the user to backspace or clear an incorrectly entered number or PIN, so that the user can clear the erroneous entry and try again to enter the correct number or PIN. In one variation, the correct key 37 can allow the user to delete an incorrectly entered PIN as long as the enter key 36 has not already been pressed by the user. In one implementation, the keypad 34 comprises a capacitance film whose individual keys 35 are activated when touched by the user's finger. Other suitable electrical, electromechanical or other types of input keys can also be used whether currently available or hereafter developed.

The smart card 10 (FIGS. 1 and 3) can also include a display device 60. The display device 60 can include a display screen 66, as well as a display power button 64. The display screen 66 can be, by way of example, a liquid crystal display (LCD). The LCD can be powered via a battery (not shown) internal to the smart card 10, or via a photocell (not shown) placed on the surface of the smart card to provide power to the LCD via ambient lighting. The display power button 64 can be used to provide illumination power to the display screen 66.

The smart card 10 of FIGS. 1 and 3 can also include the following components:
(1) a processor 78 (or microprocessor “MP”) to process information received by, and issued by, the smart card 10 (as well as for performing calculations internal to the smart card);
(2) a power supply 72 (indicated by icon “e⁻”), which can be a battery and/or a capacitor, and which can be used to provide electrical power to components within the smart card (such as the processor 78, the display screen 66, the user interface 30 and the communications module 74 (described below);
(3) a photovoltaic cell (“photo-cell”) 76 which can be used to convert ambient light into energy for charging the power supply 72, or for directly powering electronic components within the smart card via an internal power conversion circuit (not shown, but known in the art);
(4) a communication circuit (“COM”) 74 which can be enabled to provide wireless communications between the smart card 10 and devices external to the smart card; and
(5) a computer-readable memory device (“MEM”, FIGS. 2 and 4) which can be used to store relevant data in (i) read-only memory, and/or (ii) random access memory (i.e., read-write capable memory).

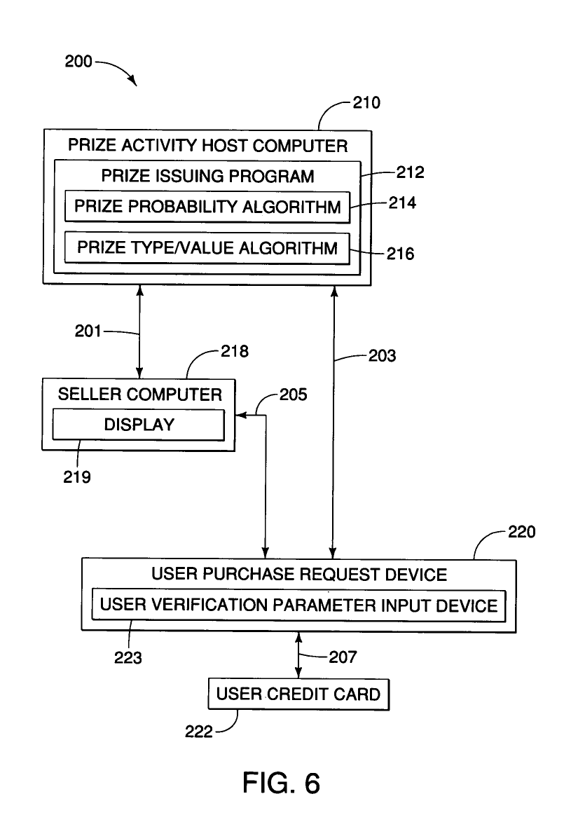

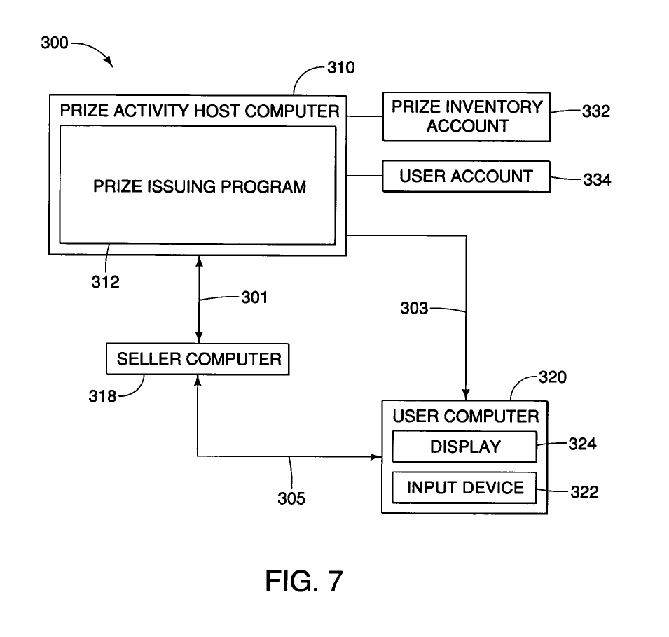

The communication circuit (“COM”) 74 of the smart card 10 (FIGS. 1 and 3) can be configured to provide wireless communication on a local level (e.g., by radio frequency-type communication such as Bluetooth® (a registered trademark of the Bluetooth Special Interest Group), or on a wide scale level (such as via a cellular communication link). Typically, wireless communication on a local level is limited to a range of less than about 1 mile in a radius from the smart card 10, and wireless communication on a wide scale level is not limited. Accordingly, the communication circuit (“COM”) 74 of the smart card 10 can provide information to, and receive information from, entities such as (by way of example only) a seller computer (items 218 and 318 of respective FIGS. 6 and 7, described below) and a prize activity host computer (items 210 and 310 of respective FIGS. 6 and 7, also described below). Such wireless communications can be encrypted so that sensitive information (such as user identification information, passwords and user account information) cannot be intercepted by third parties. The communication circuit 74 can be used in conjunction with a purchase request from a user in order to consummate a purchase by the user (as will be described more fully below). The communication circuit 74 can include circuitry (not shown) powered by the photocell 76, or a capacitor (or equivalent power storage device as part of power supply 72) to detect the transmission of an incoming or outgoing message, and thereafter to fully energize the communication circuit 74 (via the power supply 72) for further communications. That is, the communication circuit 74 can include a power-saving circuit with a wake-up feature in order to preserve power in the power supply 72.

Referring to FIGS. 3 and 4, in another implementation the input device or other detector 30 can comprise a biometric sensor 40 adapted to receive the authentication parameter and any other needed data. The use of any suitable biometric sensor is further contemplated, whether now known or hereafter developed. In FIG. 4 the biometric sensor 40 is configured to receive the user's fingerprint or thumbprint which can then be used as the authentication data or parameter. When such a biometric sensor 40 is employed, the step of entering authentication data can comprise the user placing a digit 41 (such as his or her finger or thumb) on the biometric sensor 40. Once the biometric sensor 40 has scanned or otherwise read the fingerprint, thumbprint, etc. (i.e., authentication data), the fingerprint data is sent to the processor (as described below).

As can be appreciated from the above, credit and/or debit payments contemplated hereunder can also include payments made by a user via a portable electronic device such as a cell phone, a tablet device, and/or a laptop computer. In general, portable electronic devices (as contemplated hereunder) allow a user to make a purchase via a wireless communication connection (either directly or indirectly) between a seller and a buyer (user). In this case the portable electronic device can require entry of a verification parameter (e.g., entry of an identification (or verification) code or entry of a biometric parameter via a touch screen or the like) in order to verify and authorize a credit (or debit) payment to be made to a seller by a user via the portable electronic device.

In another variation, a verification parameter can be provided by the user at the seller's place of business (or via a portable electronic device provided by the seller). For example, a seller can have a magnetic swipe card reader that also includes a numeric keypad and/or a biometric sensor (such as a fingerprint reader). (It will be appreciated that the keypad and/or biometric sensor can also be supported on a touch-screen provided by the seller, or on a separate electronic device.) In any event, the keypad and/or sensor allows the buyer (user) to input their verification information (e.g., PIN or fingerprint) at the time of purchase, while the magnetic swipe card reader allows the user to provide the account number to which a purchase is to be charged or debited. The verification information and account number are transmitted electronically to the credit entity (or debit entity), who then performs a check to see if the transmitted verification information corresponds to verification information on file with the credit entity and associated with the transmitted account number. (The on-file verification information can be provided to the credit entity at the time the account is initially set up by the user and the credit entity.) If the transmitted verification information matches the on-file verification information, then the credit entity transmits to the seller information indicating that the sales transaction is a verified transaction, and the sale can thereafter be completed.

In the case of a smart-card (described above) wherein the keypad and/or biometric sensor is provided on the card itself, and for a sale at the seller's place of business, the transaction can be verified (i.e., the user verified as the authentic holder of the credit account corresponding to the smart card) as follows. First, the user enters the verification information into the card. An on-board processor (on the card) compares the entered verification information to verification information previously stored in a computer-readable memory also supported on the card. (The verification information previously stored in the computer-readable memory can be stored at the time the card is provided to the user as part of a setup procedure, such as by the user going to a physical bank or the like and entering the verification in the presence of a bank employee who can verify the identity of the user such as by reviewing the user's driving license or the like. The verification information stored in the memory on the card can be stored in a read-only memory device to prevent tampering. Alternately, access to the memory locations wherein the original verification information is stored can be restricted by encryption, with the credit entity having the encryption code allowing access to the restricted memory locations.) At any rate, when the on-board processor determines that the currently entered verification information matches the stored verification information, then the processor can energize a portion of the magnetic strip on the card to enable the account number to be read from the magnetic strip by a magnetic card reader. Once the account number has been read, the energizable portion of the magnetic strip is reset so that the account number cannot be read again unless the verification information is re-entered. Alternately, the card can be first presented to the seller for scanning, and then once scanned, a display on the card reader (or on the card itself) can prompt the user to enter the verification information into the card, and the card is re-swiped to provide the verification information to the credit entity. In another variation, the user can first enter the verification information into the card and the verification information is stored in temporary memory on the card. The seller then swipes the card, at which time both the account number and the verification information are transmitted to the credit entity for authentication in the manner described in the paragraph above.

A recent innovation in credit card purchases is a credit card reader (magnetic swipe reader) that can be plugged into a data access port on a smart phone (i.e., a cellular telephone having enhanced capabilities) or the like (such as tablet devices). Since many smart phones also incorporate biometric touch-screen technology to restrict access to the smart phone to the legitimate user of the phone, this technology can also be used to accept biometric verification information from a buyer (user). In addition to, or alternative to, the use of the smart phone biometric sensor, a virtual keypad displayed on the screen of the smart phone can also be used to allow the user (or the seller) to enter a PIN or the like. In this instance the smart phone can be owned by either the seller (vendor) or the user (buyer). In any event, once the verification information is entered into the smart phone and the card read by the smart phone supported card reader, the input verification information and the account number can be transmitted wirelessly or otherwise (and preferably in a secure encrypted manner) to the credit entity for verification of the purchase currently being undertaken.

The foregoing description of various methods and apparatus that can be used to verify a credit account (or debit account) purchase are provided to facilitate understanding of the following description of how various methods and apparatus of the present disclosure can be implemented. However, it will be appreciated that the apparatus, systems and methods disclosed herein are not limited to use with account verification methodologies and technologies, and the disclosed apparatus, systems and methods can be used with less secure credit and debit purchase transactions.

### GENERAL ASPECTS OF METHODS OF THE PRESENT DISCLOSURE

In general, the present disclosure provides for methods, apparatus and systems for generating prize opportunities to users of credit accounts (and/or debit accounts) when the account is used for a purchase activity by the holder of the account, and to issuing prizes to such users. (A purchase activity is any purchase by a user—i.e., a holder of a credit or debit account—from a seller or vendor in which the purchase is to be charged against the user's credit or debit account.) More specifically, according to methods disclosed herein, a credit or debit entity can host a prize giving activity to its account holders (i.e., users). Preferably, the opportunity for a user to win a prize is based on the user making a purchase using a user account hosted (and/or provided) by the credit/debit entity. (As indicated previously, methods etc. disclosed herein can be practiced by credit entities and debit entities alike. However, for simplification of the following discussion, I will use the term credit entity to mean both credit entities and debit entities, unless specifically limited to one or the other as per the then-current discussion/description. Likewise, a credit account or a debit account will be generically referred to herein as an account, unless specifically limited to one or the other as per the then-current discussion/description.) As indicated, according to the methods provided for herein, the opportunity for a user to win a prize offered by the credit entity is based on the user making a purchase to be funded by the user's account with the credit entity. Thus, in general (but subject to potential limitations, as described below), the more often a user makes a purchase using their credit account, the higher will be their probability for winning a prize offered by the credit entity (which hosts the user's credit account). As can be appreciated, this opportunity for a user to be eligible to win a prize which is based on making purchases from a credit account will be an incentive for a user to use the account more often. Thus, credit entities will be inclined to offer these prize opportunities to their account holders since the revenues generated from the increased account usage will likely offset the costs of hosting the prize activity, as well as the costs of any prizes given (or issued) thereunder. I will use the expression “prize activity” to mean the project or schema disclosed and described herein for hosting and/or administering the giving (or issuing) of prizes to a limited number of users based on their use of a credit or debit account to make a purchase. The expression “prize activity” as used herein will also include the process of determining if a user is eligible for a prize, and determining the value and/or kind of prize to be given. The prize activity disclosed herein can be hosted and administered either directly by a credit entity, or on behalf of a credit entity. In addition, the prize activity disclosed herein can be administered by a single entity (e.g., a credit entity), or by two or more entities (e.g., a credit entity in conjunction with an accounting entity). (An accounting entity can be, by way of example, an independent certified accountant or an independent accounting firm.) I will also use the term “issue” herein (and verb tense variations thereof, such as “issued” and/or “issuing”) with respect to prizes to indicate that a prize has been allocated to a user (i.e., the user has won a prize), or that a user is eligible to win a prize from among a selected group of users. The mere fact that a prize has been issued to a user does not imply that the user has claimed the prize.

Preferably, the costs of hosting the prize activity are funded by revenues generated by the credit entity, and are not based on a fee charged to users for the sole (or primary) purpose of participating in the prize activity. The cost of prizes given under the prize activity can be funded by the credit entity, a third party (e.g., a seller), or a combination thereof. Thus, in the preferred embodiment, users do not pay a fee in order to participate in the prize activity, and thus all users (i.e., account holders) are eligible to participate.

As indicated above, the opportunity to win a prize is based on users making a purchase using an account hosted by the credit entity offering the prizes. More preferably, the user is notified essentially at the time that a purchase is made (i.e., at the time the purchase request is authorized) whether or not the user has won a prize. That is, prizes are generally (and preferably) given or issued at the time of purchase (subject to verification in certain circumstances, as described more fully below), and not based on a periodic basis (such as a monthly account statement). This aspect of giving (or issuing) prizes essentially at the time of purchase (i.e., at a time essentially immediately following authorization of a purchase request—i.e., within 30 seconds or less of the purchase request being authorized, provided that no time lags are introduced as a result of telecommunication interruptions) increases interest on the part of users, since they may receive an instant prize based on making a purchase. (The issuing or giving of a prize to the user essentially comprises making the prize accessible to the user, but not necessarily delivering the prize to the user at that instant. In some instances prizes, once issued or given, will need to be redeemed or claimed by the prize winner.)

According to one generic embodiment, when a user makes a purchase using a credit account, the user is offered an opportunity to win a prize offered by the credit entity hosting the credit account. The opportunity to win a prize may or may not result in the user actually winning a prize. The user is notified of the results (e.g., a prize has been won) essentially contemporaneously with the purchase being made (subject to certain limitations, as described below). The determination of whether or not a prize has been won can be based on a prize issuing program (described more fully below) established and managed by (or on behalf of) the credit entity.

Prizes

Prizes that can be provided by the credit entity to users can include (but are not limited to) the following: (i) an instant cash prize (which can be either credited to the user's account or provided in cash by the seller); (ii) an instant purchase prize that can be used to purchase additional goods/services from the seller from which the then-current purchase is being made (up to a designated amount—e.g., an instant $20 coupon redeemable for any purchase made from the seller within the next 3 months); (iii) a credit purchase prize that can be used to purchase goods/services from any seller (or a specific seller) up to a designated amount—e.g., a $20 credit coupon redeemable for any purchase made within the next 3 months; (iv) a discount purchase prize to purchase goods/services from (a) any seller, (b) a designated seller, or (c) the instant seller, for a designated discount (e.g., a 25% discount for any purchase made within the next 3 months); (iv) a grand prize (such as a new automobile, a vacation or a large cash amount); (v) an opportunity to be eligible for a grand prize (for example, in a drawing to be performed later); (vi) a gift certificate; and/or (vii) any other prize which will be an incentive to a user to make a purchase based on the opportunity to win the offered prize.

The value of a prize to be given to a user can be independent of the value of a purchase (or accumulated purchases) made by the user using the credit account. Similarly, the probability that a particular user will win a prize can be independent of the value of a purchase (or purchases) made by the user using the credit account. Alternately, the value of a prize, and/or the probability that a particular user will win a prize, can be dependent on the value of a purchase (or the value of cumulative purchases) made by the user using the credit account.

Prizes to be issued by the credit entity during the prize activity can be randomly selected (from among an inventory of available prizes) for issuance to a winner at any time during the prize activity. In addition, a prize to be provided by the credit entity during the prize activity can also be of a progressive nature. As an example of a progressive prize, a prize issuing algorithm (describe more fully below) can be configured to issue (or give) to 1,000 of the first 100,000 users (who make a purchase of $1,000 or more using their credit account) the opportunity to participate in a progressive prize. The progressive prize can initially be set at a sum-certain (e.g., $10,000). If any of the 1000 eligible participants then makes a purchase (or purchases) of $1,000 or more (using their credit account) within the next 3 months (for example), then the $10,000 prize will be issued (given) to one of the 1,000 eligible participants (based on a random selection). However, if none of the 1,000 eligible participants makes a purchase of $1,000 or more within the next 3 months (for example), or the prize is not given, then the prize increases to $50,000 (for example), and the eligibility for this $50,000 prize increases to any of the 1,000 eligible participants making a purchase (or purchases) of $2,000 or more within the next three months (for example), and using their credit account. This schema of increasing the prize amount as a function of the value of purchases made by users (until the prize amount is ultimately issued to a winner) will have the effect of urging users to charge ever greater amounts to their credit account in the hopes of winning the progressive prize.

In yet another variation prizes can be issued or given based on selected categories of purchases made by the user using the credit account. For example, prizes can be issued in the following categories: (1) travel purchases (including lodging and dining); (2) gasoline purchases; and (3) home improvement purchases. Thus, when a buyer make a purchase from a seller in one of the special categories, the user can be eligible to win a prize in that category. For example, if the category is travel, then purchases made in that category can make a user eligible to win a prize within that category (such as, for example, a free airline ticket).

Collaborative Efforts Between a Seller and a Credit Entity

According to certain embodiments, a credit entity can enter into a collaborative effort with one or more sellers to sponsor and offer prizes to users. That is, a seller (current or potential) can provide funding to a credit entity to allow the credit entity to offer (and issue) a prize (or prizes) to users which can be used for future purchases to be made from the sponsoring seller (for free merchandise and/or services and the like). This can take many different forms, as for example: (i) the seller of a current purchase can offer to subsidize a prize for a discount or a cash credit for a future purchase from the same seller; (ii) a competitor of a current seller can offer to subsidize a prize for a discount or a cash credit for a future purchase from the competitor; and/or (iii) any seller can offer to subsidize a prize for a discount or a cash credit for a future purchase from the offering seller. In any event, the methods disclosed herein contemplate that any such prize will be provided to the user at the time that a purchase is made from a seller using an account hosted by the credit entity. As one specific example following item (ii) above, a credit entity can establish a collaborative agreement with hardware store “A” to the effect that if a user makes a purchase from any other (specifically identified) competing hardware store using a credit account hosted by the credit entity, then the credit entity will offer a prize (such as a discount or a credit) to the user to encourage the user to make a future purchase from hardware store “A” (and in this case the prize will be funded at least in part by hardware store “A”). Of course, the credit entity can entertain bids from competitive sellers in order to obtain supporting funding for the prize activity.

Other Collaborative Efforts

In addition to the collaborative efforts between a seller and a credit entity (as described above), other collaborative efforts can be arranged as part of the prize activity provided for herein. In the following discussion I will refer to a prize provider. A prize provider is the original source of prizes. For example: if the prize is an automobile, then the prize provider can be the manufacturer of the automobile; and if the prize is a sea cruise, then the prize provider can be the cruise line. Prize providers can supply prizes to the credit entity, who then issues the prizes to users under the prize activity. Prizes can be supplied to the credit entity by the prize providers in a number of different ways, including (without limitation): (i) sale of the prize to the credit entity; (ii) transfer of title to a trustee; and (iii) by way of a promissory note to provide the prize when the issued prize is claimed by the user. A credit entity offering the prize activity can thus enter into a collaborative effort with one or more prize providers. In one example, the prize provider can agree to provide the prizes at no cost (or reduced cost) to the credit entity in exchange for an agreed-upon amount of advertising or exposure. For example, if the grand prize is a new automobile manufactured by a certain car company, then the car company can provide the automobile to the credit entity for free (or reduced price) in exchange for visible promotions on the credit entity's web site (e.g., “You could be the winner of a brand new Glamora B580 luxury sedan by making purchases using your account” (“Glamora” and “B580” are fictitious marks used for illustrative purposes only)). As can be appreciated, such collaboration can extend to any kind of prize, including cash prizes and prizes of services (e.g., free internet service for one year).

Notification of Issue of, or Eligibility for, a Prize

As indicated above, preferably prizes (or notification of eligibility for a prize) are provided to the user at the time that a purchase is made by the user using a credit account hosted by the sponsor of the prize activity. In order for the user to know that he/she has instantly won a prize (or is now eligible for an opportunity to win a prize), it is desirable that the user be provided with notification at the time that payment for the purchase has been approved. This can be done in a number of different ways. Preferably, the seller has under its control a computer (which can be linked to, or part of, a cash register or a credit card scanner having a digital display). More preferably, the seller computer includes a computer readable memory device having a dedicated read-write memory address for storing (at least temporarily) prize information which can be sent electronically to the seller by the credit entity. Prize information can include the following: the type and/or value of the prize which has been issued to the user; information to allow the user to redeem the issued prize; and information regarding a potential sweepstake drawing for a grand prize.

In a first variation, if a seller submits the user credit account number and a request for authorization of the purchase (purchase authorization request) to the credit entity, and the seller has a seller computer (as described above) linked to a digital display device, then the credit entity can electronically transmit a prize notification message (i.e., notification that a prize has been issued or given) back to the seller, and the notification can be displayed on the digital display device. The notification can be (by way of example only) something along the lines of: “Congratulations! You have won an instant credit of $50 for a purchase from this seller. Please see your printed sales receipt for further details.” In this case, the printed sales receipt (generated by the seller for the buyer/user) can include details of how to redeem the issued prize, the time period for redeeming the prize, a description of the prize, the value of the prize, and any other information which may be necessary in order to allow the user to redeem the prize (such as an access code or the like), as well as any legal notifications which may required or desirable to provide to the user).

In the instance where a credit purchase is made at the point-of-sale using a smart credit card (which includes a display device), the credit entity (following approval of the purchase) can send a notification to the seller computer (e.g., by way of an electronic message which can be displayed on a linked digital cash register or credit card scanner under the control of the seller) that the user should scan his/her credit card again (using the seller credit card scanner) to receive information regarding possible issue of a prize to the user (buyer). At the time that the message requesting re-scanning of the smart credit is sent to the seller, the credit entity can also transmit information regarding the prize won by the user (or other prize information, such as prize eligibility information), and this prize information can be temporarily stored in the dedicated prize information address at the seller computer. The user can then submit the credit card to the credit card scanner again (with or without re-submitting account verification information), and the prize information can then be transferred electronically to the users smart card, and can be stored in on-board computer readable memory on the smart card. (And at the time of transferring the prize information to the user's smart card, the prize information can be erased from the computer readable memory on the seller computer). The prize information can then be displayed to the user via the on-board display device on the smart card. This information can be presented, for example, in the way of a scrolling message on the smart card display device. An example of this prize information that can be presented to a user on his/her smart card display device is as follows: “Congratulations! You have won a prize of $50 towards any future purchase from BigCo Hardware.” [“BigCo Hardware is a fictitious name used for exemplary purposes only.] The message can go on to say (for example): “For details, please access your account online at creditentity.com.” [“creditentity.com” is a fictitious name used for exemplary purposes only.]

The benefits of the embodiment described immediately above (regarding providing prize information to be displayed on a display device on a smart credit card) are at least twofold. First of all, the embodiment allows prize information to be stored on a user's smart credit card. Such prize information can be later used (and provided) by the smart credit card in methodologies described further below. Secondly, this embodiment allows prize information to be provided to the user only (and not to the seller of the current transaction). (In this latter instance, the memory address on the seller computer where the prize information is temporarily stored can be a protected memory address, accessible only by the credit entity, such that the seller cannot access the contents of the memory address. The arrangements for providing a secure memory address on the seller computer can be provided for by an agreed arrangement between the seller and the credit entity.) There are a number of advantages to providing prize information to the user alone, and not to the seller. One advantage is for personal security of the user. For example, if the user is the winner of a $100,000 prize, then it is reasonable that the user (i.e., the winner of this prize) desires this information to be held in confidence, and not become publicly known (which it could be if, for example, a seller employee were to be made aware of the issued prize). Another advantage is that if the prize is for a credit to a competitor (see description above regarding issuing prizes to competitors of sellers in a collaborative arrangement between the credit entity and the competitor), then the current seller will not be aware of this issuing of a prize to the benefit of their competitor. Regarding prize information stored on a smart credit card, the prize can be redeemed by, for example, scanning the smart credit card at the time of a future purchase and allowing the seller computer to determine from the smart card that the user is entitled to a prize, such as a credit or discount from the seller. (For example, if the prize is for a credit from BigCo Hardware, then when the smart card is read by a seller computer from BigCo Hardware, the smart card will indicate to the BigCo Hardware seller computer that the user is entitled to a credit, discount or the like.)

In a third variation, notification of the issue (or winning) of a prize (or eligibility for a prize) can be provided to a user (i.e., a buyer or purchaser) when a purchase is made electronically and not at the site of the seller (as is contemplated in the descriptions provided above). The most common instance of such a purchase is a purchase made on-line (such as via the internet) by a user employing a user computer (i.e., a computer under the control of the user at the time of the purchase) from a seller having a seller computer hosting a seller website. (It will be appreciated that the seller computer can be a computer owner by a third party who is under contract to provide computer services to the seller. Similarly, the seller website can provided and/or hosted by one or more third parties under contract to the seller.) In this instance, a common transaction is for a user to indicate to the seller (via an on-line electronic communication) that the user wishes to make a purchase using a credit account. The user then submits to the seller the credit account information, and the seller then forwards the users credit account information to the credit entity for verification of the user credit account (and this can be accompanied by a purchase authorization request from the seller, requesting that the credit entity authorize the purchase being requested by the user). The credit entity can respond to the seller with verification of the user information and authorization of the purchase, and can also at that time electronically transmit to the seller prize information regarding the issuance of a prize to the user. The seller can then forward to the user (along with confirmation of purchase and verification of acceptance of the charge to the users credit account) the prize information. For example, if a user makes an online purchase from BigCo Hardware [a exemplary fictitious seller] and provides credit account information to the seller to pay for the purchase, then the seller electronically submits the credit account information to the credit entity for verification. Once the credit entity authorizes the purchase (and the charge against the user's credit account) by way of electronic communication to the seller, then the credit entity can also forward along to the seller the prize information, which can be stored (temporarily at least) in a secure memory location (or address) on the seller computer. (As indicated above, access to this memory address can be limited by way of agreement between the seller and the credit entity.) The seller can then transmit electronically to the user not only verification that the purchase has been accepted, but also information regarding the issuance of a prize. For example, if a user makes an online purchase from the seller “bigcohardware.com” [a fictitious entity used for exemplary purposes only] and makes payment by submitting the user's credit account information to “bigcohardware.com”, then “bigcohardware.com” electronically transmits to the respective credit entity the user account information, a request for verification of the purchase, and any account verification information provided by the user. The credit entity then responds to the seller by either denying the transaction or accepting the transaction. If the credit entity accepts the transaction, then the credit entity can transmit (electronically) to the seller not only transaction authorization information (i.e., information to the effect that the purchase has been verified and is authorized, thus allowing the seller to consummate the sale) but also prize information to the effect that the user has won (or is eligible to win) a prize. The prize information can be sent along to the user (by the seller) along with sale verification information. (For example, an online vendor (seller) can send to a user the following message: “Your transaction has been approved—your transaction number is provided below. CONGRATULATIONS—your credit card provider has informed us that you have won a prize based on your purchase. For details on your prize, please click here.” [And the “click here” indicator can provide a hyperlink for the user to obtain details regarding the prize.]

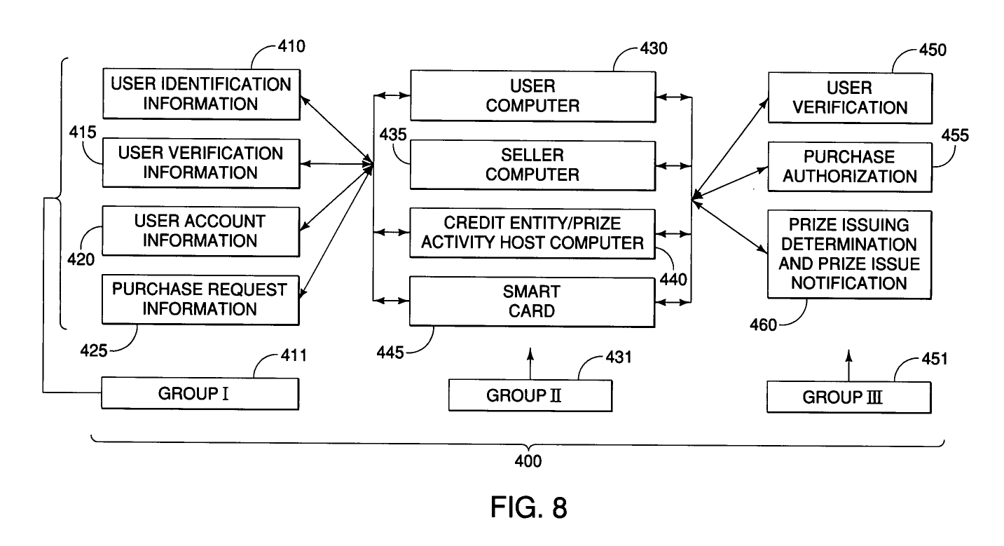

When payment is made via a smart credit card (or smart card, such as item 10 of FIGS. 1-4, described above) which includes a communications circuit (e.g., communications circuit 74 of FIGS. 1 and 3, also described above), then the notification to the user of the issue of a prize (as well as the underlying purchase transaction) can be performed in additional ways to those described herein (both above and below). The methods for use of a wireless communications enabled smart card can be categorized by the type of wireless communications circuit 74 (i.e., depending on whether the communications circuit 74 is configured to communicate on a local level or on a wide scale level). Regardless of whether the communications circuit 74 is configured to communicate on a local level or a wide scale level, there are two distinct possibilities: (i) the user makes a purchase at a seller location; or (ii) the user makes a purchase remote from the seller location. The most common example of the latter instance (i.e., the user making a purchase remote from the seller location) is when a user makes a purchase online using a credit account, and there is no means available for the smart credit card to communicate in a physically directly manner (e.g., by a magnetic strip on the card being physically read by a magnetic card reader) with either the seller computer or the credit entity. Further, it will be appreciated that a user computer, a seller computer and a credit entity computer (or prize activity host computer) can all be configured with communication circuitry (not shown in the drawings, but known in the art) to accept wireless communications in a local level format (e.g., a Bluetooth communication circuit) as well as in a global level format (e.g., cellular or satellite communication). In general, in order to consummate a purchase (as well as to optionally issue a prize) to a user using a smart card having a wireless communication circuit, a number of different communications schemas can be used, as described below with respect to FIG. 8.

FIG. 8 is a block diagram depicting a matrix 400 of communicated information and various communication devices, and how communication of the communicated information can be distributed among the various communication devices in accordance with the current disclosures. More specifically, the matrix 400 of FIG. 8 includes three groups, as follows: Group I (411) comprising submitted information which is sent as part of an activity to make a purchase; Group III (451) comprising responsive information which is generally sent in response to the submission of Group I submitted information (or part thereof), and; Group II (431) comprising various communication devices and/or entities which can be used to affect the receipt, processing and transmission of Group I and Group III information. The submitted information (Group I, 411) can include the following: user identification information 410; user verification information 415; user account information 420; and purchase request information 425. The responsive information (Group III, 451) can include the following: user verification information (450); purchase authorization information (455); and prize issuing determination and/or prize issuing notification (460). The various communication devices and/or entities of Group II (431) can include the following: a user computer 430; a seller computer 435; a credit entity and/or prize activity host computer 440; and/or a smart card 445.

In FIG. 8 the bi-directional arrows between the submitted information of Group I (411) and the various communication devices and/or entities of Group II (431), as well as the bi-directional arrows between the responsive information of Group III (451) and the various communication devices and/or entities of Group II (431), indicates that the current disclosure contemplates (and encompasses) all of the possible combinations and permutations for the submitted information (of Group 1, item 411) and the responsive information of Group III (451) via the various communication devices and/or entities of Group II (431). I will now provide an example of how a purchase and issue of a prize can be performed using a smart card (10, FIG. 1) having a wireless communication circuit (74) with reference to FIG. 8.

In this example of how a purchase and issue of a prize can be performed using a smart card (10, FIG. 1) having a wireless communication circuit (74), it will be assumed that the user is making a purchase online. (In the following example, all reference numbers will refer to FIG. 8 unless specifically indicated otherwise.) The user begins the process by contacting the seller (in this case, an online retailer) via the user computer 430 (FIG. 8). In addition to being a traditional desktop or laptop computer, the user computer 430 can be a device having an Internet browser and wireless communication capability with the Internet (such as a smart cell phone or a tablet device). The user surfs to the seller computer (435) and selects an item (goods or services) for purchase. Upon making an election to buy the item, the seller computer 435 requests payment information. The seller then enters the credit account number corresponding to the smart card 445. The seller then transmits the user account information to the credit entity (i.e., to the credit entity computer 440). The credit entity computer (440), upon determining that the user account corresponds to a smart credit card, then transmits a message back to the seller computer 435 indicating that the user needs to submit user verification information from the smart card (445). This message is then passed along from the seller (seller computer 435) to the user computer 430. Alternately, the seller computer can communicate this message directly to the user's smart card (445) via the wireless communication circuit therein item 74, FIG. 1 for display on the smart card display device 66 (FIG. 1). The seller then activates the smart card and enters user verification information (e.g., a password or PIN via keypad 30, FIG. 1, or the biometric sensor 30 of FIG. 3). The user verification information is then transmitted wirelessly from the smart card 445 (via communication circuit 74, FIGS. 1 and 3) to the credit entity computer 440. Upon verifying the user authentication information, the credit entity computer 440 then transmits a purchase authorization seller message to the seller computer 435, and the seller can complete the message. The seller computer (435) can then determine if a prize is to be issued to the user based on the purchase just made. This can be done via the prize algorithm (described herein) which is supported on the credit entity/prize activity host computer 440. If a prize is to be issued, the credit entity computer 440 transmits a prize issue notification to the user's smart card 445 via the wireless communication circuit 74 (FIG. 1). The prize issue notification can be displayed on the smart card display device (66, FIG. 1), and the user can then claim the prize by methods described herein. In an alternative configuration wherein the prize algorithm is supported on the user's smart card 445, the credit entity (credit entity computer 440), upon verifying the user's authentication information, and send a message to the user's smart card (again, via the wireless communication circuit 74, FIG. 1) instructing the smart card to run the prize algorithm. The results from the prize algorithm (and particularly, when the algorithm determines that a prize is to be issued to the user) can be communicated from the smart card 445 to the credit entity computer 440 via the smart card wireless communication circuit (74, FIG. 1). Further, in the instance wherein the prize algorithm is supported on the smart card 445, the credit entity can update the prize algorithm via the smart card wireless communication circuit (74, FIG. 1).

It will be noted that when a payment service (e.g., PayPal, mentioned above) is used to make payment for a purchase, the payment service has a user's credit information on hand (e.g., credit card or debit card number, or bank account number), and the request for authorization of payment (as well as any verification parameters) can be transmitted from the user to the credit entity for authorization (rather than the request being sent to the payment service by the seller). In this instance the credit purchase authorization information can be sent back to the user from the payment service, and then relayed to the seller (or it can be sent directly from the payment service to the seller). In any event, as part of the use of a payment service, and in conjunction with the prize activity described herein, the payment service can, prior to sending the payment authorization information, contact the credit entity for purposes of obtaining any prize information. (In this instance the payment service can also forward to the credit entity information regarding the amount of the purchase, and any other particulars which can be used by the credit entity in determining if a prize has been won by the user, and the amount and/or type of prize.) In one variation, the entity providing the payment service (payment service entity) can host the prize activity itself, independent of the credit entity.

It will be appreciated that the use of a smart card in order to make a purchase is substantially different depending on whether or not the user is able to present the card to the seller at the time of the purchase. When the user is able to physically present the smart card to the seller, then the seller computer can communicate user verification information directly from the smart card to the credit entity, and the credit entity can respond to the seller with purchase authorization information and any prize information. However, when the user is remote from the buyer during a purchase transaction and not able to send the seller electronic information from the smart card itself (such as in an online transaction or purchase made by telephone), then the user's smart card cannot be placed in electronic communication with the seller or credit entity computer. (This assumes that the user does not have a card reader available that can be placed in electronic communication with the seller and/or credit entity.) In this later instance the use of a smart credit card to make a remote purchase can be performed as follows. The user can request the smart card to provide an authorization code. This can be done, for example, by the user pressing an “Authorize” key embedded or supported on the card. The card can then prompt the user (e.g., via a display device support on the card) to provide a verification parameter to the card's on-board verification system. Once the card determines (via a processor supported on-board the card) that the user is a verified user, then the card processor can generate an authorization code (following an authentication code algorithm or using a table of previously generated authorization codes), and the authorization code can be provided to the user via the on-board display device. Then, when the user submits credit card information to a seller to complete an online purchase transaction, the user can also provide the authorization code (e.g., in lieu of the three digit CCID number). The authorization code is then transmitted by the seller to the credit entity (or by the user to the credit entity), and the credit entity can verify that the authorization code is a legitimate code for the indicated card. (By using a three digit alpha-numeric code, over 46,000 unique codes can be generated; for a 5 digit alpha-numeric code, the number increases to over 60 million codes. To provide additional security, authorization codes can be encrypted based on date generated, for example.) In one variation the seller can submit the user credit card number to the credit entity, and the credit entity, recognizing that the indicated card is a smart card, can respond to the seller by requesting an authorization code (e.g., a 5 digit code), and the seller can then forward this request for the authorization code to the user. The user can then provide the authorization code generated and supplied by the smart card. In any event, once the credit entity authorizes the purchase (based on the authentication code provided by the user to the credit entity), then the credit entity can determine if a prize is to be issued to the user. If so, the user can be notified along with verification of the purchase from the seller, or via a separate e-mail.

In one variation wherein a smart card having an onboard self-verification system is used, the card can also host the algorithm that determines if the user is to be issued a prize. When the user requests an authorization code from the card (as described above), then the smart card, in addition to providing the authorization code, can also notify the user that he or she has won a prize. As can be appreciated, this latter variation can be subject to abuse. Specifically, a user can participate in the prize activity by continually requesting authorization codes, but without actually making a purchase. This, of course, is not the intent of the credit entity hosting the prize activity. In order to reduce the impact and occurrence of this type of abuse of the prize activity, the smart card can instruct the user that they may be eligible for a prize, and to contact the credit entity (e.g., by going to a website hosted by the credit entity) for details. The credit entity website can then request that the user provide the authorization code generated by the smart card. The credit entity can then determine if the authorization code has been recently used to make a purchase, or if indeed any purchase at all has recently been made by the user using the card. If no purchase (verified or otherwise) has been made, then the website can inform the user that there does not appear to be any purchase associated with the generation of the authorization code, and thus the user is not eligible for a prize. (Published prize rules can stipulate that all prize opportunities must be associated with a purchase made by the user via the user's card, as determined solely by the credit entity.)

Publication of Prize Opportunities and Prizes Given

In order to enhance confidence among users that the prize system described hereunder is legitimate, the credit entity hosting the prize system can make available online (or otherwise) information regarding (and without limitation): (i) total prizes offered (including types and values); (ii) probabilities for users to win (or be eligible for) the prizes; and (iii) total prizes issued to date (including types and values). As indicated above, the credit entity can host a website for the prize activity. In addition to providing the information described above, the website can also allow individual card holders to maintain and log into a personal account which can include information about prizes already issued to the user, prizes issued to but not yet redeemed by the user, and eligibility for a grand prize (e.g., “Congratulations—you are one of 1,000 users who are eligible for the grand prize of a new automobile, to be given away on New Year's Day!”). General and user-specific information regarding the prize activity can also be provided to users in their monthly account statements (e.g., as a printed statement, an online statement, and/or or an e-mail statement).

Issuing of Prizes and Prize Algorithm

The issue of prizes from the credit entity to users (and based on users making a purchase using a credit account hosted by the credit entity) is in general governed by a prize algorithm. The prize algorithm is under the ultimate control of the credit entity (either directly or indirectly). The prize algorithm is preferably designed to ensure that the costs for hosting the prize activity, and the costs of the prizes themselves, are not exceeded by additional revenues generated by the offering of the prize activity to users. (For future reference, the costs to the credit entity for hosting the prize activity, and the costs of the prizes themselves, will be referred to herein as prize costs.)

In its most simple form, the prize algorithm is based on setting aside a predetermined prize pool to be funded from revenues generated by the credit entity. Further, under this most fundamental form, prizes can be provided based on a simple algorithm of next-user-activity equates to next offered opportunity to win a prize. Under this example, the credit entity can set aside a sum-certain (e.g., $10 million) of its revenues to be provided to users as prizes within the next calendar year. Further, under this most fundamental form, prizes can be provided based on a simple calculation of number of prizes to be given (“N”) and number of anticipated transactions (“T”) during the period. The equation to determine the frequency of prize giving is thus NIT. Thus, for example, for 1,000 (“N”) prizes to be given based on 10 million anticipated transactions (“T”), the frequency of prize giving is 1,000/10,000,000, or 1 prize for every 10,000 transactions. For a prize pool of $1 million, this equates to an average prize of $100. Under this simple formula, every user has a chance to win a prize of $100 based on making 10,000 transactions. However, in order to stimulate increased interest in the prize activity (and thus user activity of their credit accounts), it is desirable to provide a prize algorithm which offers incrementally greater opportunities to win a prize based on increased use of a user account, and/or the amount of purchases made by a user using the user account. In one variation, in order for a user to be eligible to win a prize under the prize activity, the user can be required to make a purchase of a set minimum amount (for example, $10). Such a requirement will prevent users from making a large number of purchases of a very small amount (e.g., purchases of $0.01) in order to increase their chances of winning a prize.

In one variation, the prize algorithm can be provided as a two-part algorithm. The first part is a prize probability algorithm to determine the probability (prize probability, or PP) that a prize will be issued to a user; the second part is a prize value algorithm to determine the value of a prize (prize value, or PV) that can be issued to a user. The overall issuing of prizes will thus be a function of these two algorithms, as well as a function of the overall available pool of funds from which prizes can and will be issued or given.

PRIZE PROBABILITY ALGORITHM. In one variation the probability of winning a prize is generated by a prize probability algorithm that generates a random number (“RN”). Many such algorithms for generating random numbers are known. The prize activity can provide that when a preselected number is generated by the random number generator algorithm, then a prize is issued. For example, if one prize is to be issued for every 10,000 transactions, then the prize probability algorithm can be configured such that random numbers between 1 and 10,000 are generated, and when a preselected arbitrary number (such as 5,000, for example) is generated then a prize is issued. Once a prize is issued (assuming the winning preselected arbitrary number is generated during the first 10,000 purchases), then no more prizes (at least within a selected prize category) are issued until 10,000 purchase transactions have been completed. However, if no prize is issued during the first 10,000 transactions (i.e., the preselected arbitrary number is not generated during that time), then the prize can be issued on the very next transaction, and the prize activity then moves on to the issuing of a prize for the next 10,000 transactions. (The numbers used above are for exemplary purposes only—the frequency of issuing prizes, e.g., every 10,000 transactions, can be increased (e.g., a prize every 7,500 transactions) or decreased (e.g., a prize every 100,000 transactions.)

As indicated above, in one variation the probability for a user to be eligible to win a prize can be increased based on the total value of purchases made by a user during the time period established for the administration of the prize activity. For example, if the prize activity is established to run for one year, then the total value of purchases made by a user during that year can be used as a factor in determining the user's eligibility to win a prize. In this example, the more the user purchases (in total accumulated purchase amount) using the credit account, the greater will be his or her probability of winning a prize. This can be done in a number of different ways. In a first example, the prize probability algorithm can be configured to generate the random number multiple times based on a user's total value of purchases. For example, for users with current total purchases of between $10 and $999, the random number is generated only once for the next transaction for which the users are eligible for a prize. However, for users with current total purchases of between $1,000 and $5,000, the random number is generated twice for the next transaction for which the users are eligible for a prize. (That is, users having made total account purchases of between $1,000 and $5,000 are twice as likely to win a prize as are users who have made total purchases of less than $1,000.) In this instance the prize probability algorithm can also be configured to add to a user's amount of current total purchases the value of the instant transaction being performed.

In the example just given it was described how the prize probability algorithm can be configured to generate random numbers multiples of times in order to give users with higher total purchases greater opportunities to win a prize. However, that only allows the odds to be incremented in multiples—e.g., two times, three times, etc. In a second example the prize probability algorithm can be configured to increase the odds at a slower rate. In the second example, the random number generator can be configured to generate a larger range of numbers. Then the odds of winning a prize can be increased at finer increments. For example, if the odds of winning a prize are set at 1 in 10,000, then the random number generator can be configured to generate (for example) 10 million numbers (e.g., numbers 1 through 10,000,000). Thus, of the 10 million numbers that can be generated, if 100 of those numbers are selected to be numbers for which a prize can be won, then the odds of winning a prized (based on any one of the 100 selected numbers) still gives odds of 1:10,000. For purposes of the example, let us say that numbers 5,000,000 through 5,000,099 are the selected 100 numbers. Let us then presume that the prize activity is configured to provide users with greater chances of winning based on each additional $400 of total purchases made using their credit account. In this case, the number of random numbers for which a user is eligible to win a prize is increase by 1 for each $400. By way of example, if a user has made total purchases of $2,400, then the range of random numbers for which this user can win a prize is increased by 6 ($2,400 divided by $400 is 6). Thus, the range of random numbers for which this user is eligible to win a prize is extended to numbers from between 5,000,000 and 5,000,105. That is, in this example the user has increase his or her odds of winning a prize from 1 in 10,000 to approximately 1 in 9,434. As can be appreciated, the various numbers used in the above example can all be modified as desired by the credit entity in order to establish the rules for the prize activity.

PRIZE VALUE ALGORITHM AND PRIZE TYPE ALGORITHM. The value of prizes to be issued to winners can be set (i.e., not variable), in which case the prize value algorithm is basically a look-up table. For example, the first 500 prizes to be issued can be $10 prizes (with perhaps 10 of the first 500 prizes being $100 prizes), the next 300 prizes to be issued can be $25 prizes, the next 200 prizes to be issued can be $50 prizes, and so on. However, as with the prize probability algorithm (described above), the prize value algorithm can be configured to increase the value of potential prizes to be issued to a user based on the current value of purchases made by the user (including any then-current purchase being made). For example, using the look-up table example provided above, if a user has made total purchases of $2,000 or more, then the value of the prize from the look-up table can be doubled (or trebled for total purchase of $4,000 or more). Further, a plurality of look-up tables can be provided, and the look-up table to be used for any particular transaction by a particular user can be selected based on the total purchases made by the user or other criteria.

The plurality of look-up tables can also provide for different prize types and categories. For example, a suite of look-up tables can include the following prize types: cash prizes; travel and lodging prizes; dining prizes; gift certificate prizes; instant credit at seller prizes; and grand prizes. In this case the particular look-up table (or tables) to be used can be selected based on a number of different factors. In one example the particular look-up table which can to be used can be selected based the current purchase being made. For example, if a user is currently purchasing airline tickets, then the look-up tables which can be used can be selected to include travel and lodging prizes, and cash prizes. If more than one look-up table is selected for possible use, then the particular look-up table to be used for the particular transaction at hand can be selected by a random number generator. (For example, for two possible look-up tables to be used, only two possible random numbers are generated—the first random number being associated with the first look-up table, and the second random number being associated with the second look-up table.) In a variation of the example just given, if the possible look-up tables also include grand prizes, then the algorithm to select the specific look-up table can be modified to generate a larger number of random numbers—e.g., 100 random numbers, with only one such number being the number that associates with the grand prize look-up table (and the other 99 numbers being generally evenly apportioned between the travel/lodging prize table and the cash prize table). It will be appreciated that a prize look-up table can include only a single prize—e.g., the grand prize look-up table can include only a single prize of $1,000,000. From the foregoing discussion it will also be appreciated that the prize value algorithm is not necessarily restricted to the value of a prize which can be issued, but also the type or kind of prize that can be issued. Accordingly, a more inclusive name for the prize value algorithm is a prize value/type algorithm.

COMBINED USE OF PRIZE PROBABILITY ALGORITHM AND PRIZE VALUE/TYPE ALGORITHM. As indicated in the discussion above of the prize value/type algorithm, when different types and/or values of prizes are available to a user, then the first step is to select the particular prize for which the user will be eligible (typically based on the current purchase transaction being made). Once the prize type or value is selected, then the next step is to determine if the prize will be issued to the user. This next step is performed using the prize probability algorithm. A plurality of prize probability algorithms can be provided, and the particular prize probability algorithm to be used can be selected based on the type or value of the potential prize. For example, if the prize selected is a $20 gift certificate, then a prize probability algorithm providing odds of 1 in 10,000 can be used (for example). However, if the prize selected is a $100,000 cash prize, then a prize probability algorithm providing odds of 1 in 1,000,000 can be used (for example).

PRIZE ISSUING PROGRAM. As part of administering the prize activity described herein, a prize issuing program can be provided and employed. The prize issuing program comprises a series of computer executable steps for determining whether or not a prize is to be issued and, if a prize is to be issued, issuing the prize. The prize issuing program can be implemented on one or more computer processors under the control of the entity operating the prize activity described herein. In general, the prize issuing program can include computer-executable instructions to perform at least the following steps: (i) receive a request to authorize a current purchase being made by a user, the purchase to be funded from a credit account (or the like) associated with the user; (ii) determine if the request is to be authorized; (iii) if the request is authorized, then: (a) send a notification that the request has been authorized; and (b) determine if a prize is to be issued to the user (based on a prize probability algorithm); (iv) if a prize is to be issued, then send a notification that a prize has been issued to the user; and (v) perform such additional steps as are necessary to enable the user to claim the prize, and charge the cost of the prize against an account used to fund the prize.

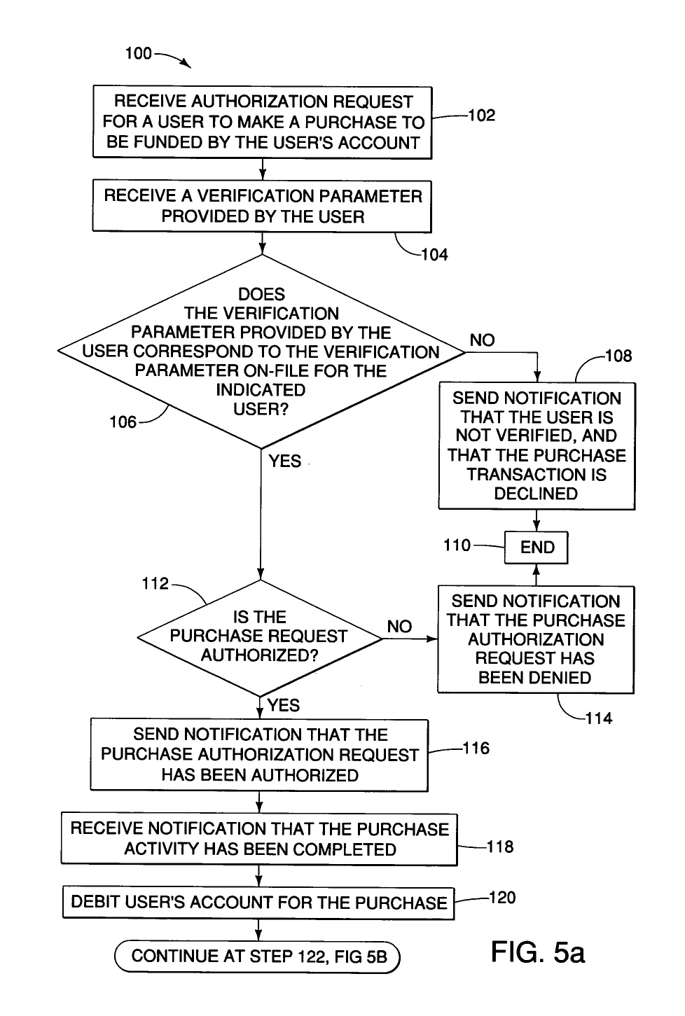

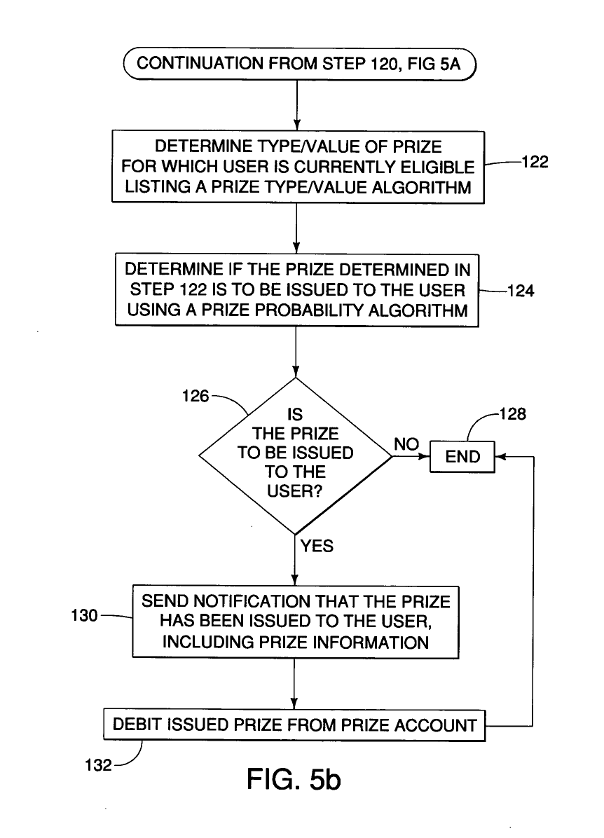

As can be appreciated from the description of the prize activity disclosed herein, the prize issuing program can include a number of additional steps beyond those described in the general example provided immediately above. One such example will now be provided with reference to the flowchart of FIGS. 5A and 5B. (It will be appreciated that the flowchart of FIGS. 5A and 5B are exemplary only, and that the flowchart can contain fewer or additional steps, and further that the steps shown in FIGS. 5A and 5B can in some instances be performed in different order.)

With reference to FIG. 5A (and continuance to FIG. 5B), an exemplary embodiment of a prize issuing program 100 in accordance with the current disclosure begins at step 102. At step 102 the prize issuing program begins by receiving an authorization request for a user to make a purchase which is to be funded by a user account. (The user account can be an account held directly by the user, or an account against which the user avers that he or she is authorized to make purchases.) It will be noted that in step 102 there is no specific designation from whence the request originates or is sent—the request can be sent from a seller, the user, or a third party intermediary (such as a payment service). The purchase authorization request received in step 102 can include the following information: (i) the account number of the user to which the purchase is to be charged; (ii) the amount of the purchase for which authorization is currently sought; and (iii) the identity of the seller (or other entity) requesting the purchase authorization request. While not shown, in addition to the purchase authorization request received in step 102, user information (e.g., regarding user identification) can also be received. It is also noted that in step 102 it is not indicated who the specific recipient is of the purchase authorization request (and any user information), but the typical recipient will be the credit entity. At step 104 the prize issuing program receives a verification parameter which has been provided by the user. Step 104 is an optional step, but has been included in this example. As with step 102, it will be noted that the verification parameter (received in step 104) can be sent from the seller, the user, or a third party. The submission (and receipt) of a verification parameter is considered to be a de facto request for the prize issuing program 100 to use the verification parameter in order to attempt to verify the authenticity of the user. Accordingly, in step 106, the prize issuing program 100 makes a determination of whether or not the verification parameter provided by the user corresponds to the verification parameter currently on-file for that user. (Various processes for making this determination have been described above.) If the prize issuing program 100 determines at step 106 that the received verification parameter does not correspond to the verification parameter currently on-file for that user, then at step 108 a notification is sent (preferably to the entity sending the authorization verification parameter in step 104, as well as to the entity sending the purchase authorization request in step 102) that the user has not been verified, and that the purchase transaction (requested to be verified in step 102) is declined. (The notification of non-verification of the user can also be sent to the user at step 108.) Thus, once user identification verification requested (ostensibly submitted in step 104) has been denied (at step 108), then in step 110 the process ends. That is, since the user identification cannot be verified at step 106, the purchase request (of step 102) is also denied, and the seller, user and/or payment service is notified (step 108), and the requested purchase transaction authorization is terminated (step 110).

However, if at step 106 the identification of the user is verified based on the provided verification parameter, then at step 112 an inquiry is made as to whether the purchase request (of step 102) is authorized. The process can include making a determination of whether or not the user's account with the credit entity (or other payment providing entity) is currently authorized to receive a charge for an amount indicated in the purchase authorization request of step 102. If, at step 112, it is determined that the purchase authorization request is not authorized (e.g., the requested amount of the purchase exceeds the current amount of credit available to the user), then at step 114 a notification is sent (preferably, to the entity sending the purchase authorization request in step 102, and also potentially to the user) that the purchase authorization request (of step 102) has been denied. Thereafter, at step 110, the process is terminated. If, however, the purchase request (of step 102) is authorized at step 112, then at step 116 a notification is sent (preferably, to the entity sending the purchase authorization request in step 102, and also potentially to the user) that the purchase authorization request (of step 102) has been authorized (or approved). Then at step 118 the entity making the purchase request (of step 102) receives notification (typically from the seller) that the purchase activity has been completed. Step 118 assumes that after sending the purchase authorization at step 116, the purchase transaction is completed (i.e., the purchase is made). However, if following step 116 a notification is sent (typically from the seller or user) that the purchase activity has been terminated and no purchase made, then control of the program 100 can move to step 110 and the program ended. (This latter variation is not shown on the flow diagram of FIG. 5A since the diagram is depicted for a completed purchase transaction). Also following step 116 if no notification is received at step 118 within a prescribed period of time (e.g., 30 seconds), then at step 118 the program can terminate at step 110 (also not shown in the flow chart for purposes of simplification).

Assuming that the requested purchase has been completed (and notification received at step 118), then at step 120 the user's account is debited for the purchase. (The flow chart of FIG. 5A continues on FIG. 5B.) At step 122, FIG. 5B, a prize type/value routine (or algorithm) is used to determine the type and/or value of a prize for which the user is eligible. As described above, the prize type/value algorithm can consider a number of different factors when making this determination. Once the prize for which the user is eligible is determined, then at step 124 a prize probability routine (or algorithm) is used to determine if the prize (determined at step 122) is to be issued to the user. (The use of a prize probability program was described above.) Then at step 126 a query is made as to whether or not the prize is to be issued to the user (based on the outcome of the prize probability algorithm at step 124). If no prize is to be issued, then the program ends at step 128. (Between steps 126 and 128 a notification can be sent (to the seller and/or user) that no prize has been won.) However, it at step 126 the answer to the query is “yes” (i.e., the prize is to be issued to the user), then at step 130 notification is sent (to the seller and/or user) that the prize has been issued to the user. The notification at step 130 can include additional prize information, such as the type of prize, the value of the prize, and details as to how the prize can be claimed. At step 132 the issued prize is debited from the prize account for purposes of accounting (i.e., to ensure that the prize activity does not issue more prizes than are funded by the activity). Thereafter, the program ends at step 128.

Prize Issuing Apparatus

Turning now to FIG. 6, an exemplary embodiment of a prize issuing apparatus 200 in accordance with the present disclosure is depicted by a block diagram. The prize issuing apparatus 200 includes as the three primary components a prize activity host computer 210, a seller computer 218, and a user purchase request device 220. I will now describe each component separately, and will thereafter describe their interaction as part of the overall apparatus.

The prize activity host computer 210 is a computer under the control of an entity which is hosting a prize activity (as described above). The hosting entity can be a credit entity or the like, or a third party under contract to the credit entity. The prize activity host computer 210 can be a single computer, or a plurality of computers placed in signal communication with one another. The prize activity host computer 210 can include a prize issuing program 212 (one example of which was described above with respect to FIGS. 5A and 5B). The prize issuing program 212 can include a prize probability program (described above), as well as a prize type/value algorithm (also described above). The prize activity host computer 210 can be placed in electronic signal communication with the seller computer 218 by communication line 201. The prize activity host computer 210 can also be placed in electronic signal communication with the user purchase request device 220 by communication line 203. The seller computer 218 can include an electronic cash register device configured to enable electronic communication with the prize activity host computer 210. Communication lines 201 and 203 can be any currently known or future means of communicating information (and particularly information in a digital format), including wireless communication (e.g., by cell phone lines, satellite communication, radio frequency communication, etc.), as well as wired communication (e.g., landlines, fiber optic cables, dedicated hard-wired communication systems, etc.). The operation of the prize activity host computer 210 in the overall apparatus 200 will be described further below.

The seller computer 218 (FIG. 6) of the prize issuing apparatus 200 can be a single computer, or a plurality of computers placed in signal communication with one another. The seller computer 218 can include a seller computer display device 219, which can be used to display communications to and from the prize activity host computer 210 and the user purchase request device 220. The seller computer can be configured as one or more electronic cash register devices (not shown) which are in (or can be placed in) electronic signal communication with one or more computers under the control of the seller. As an example, for a large retailer, the seller computer 218 can comprise a central seller computer (not shown) which is in electronic signal communication with a plurality of seller electronic cash register devices (not shown). The seller electronic cash register devices (not shown) can be located at physical retail sites of the seller, as well as via an online sales site. The display device 219 can be a display device located at each seller electronic cash register device. As indicated in FIG. 6 (and as described above) the seller computer 218 can be placed in electronic signal communication with the seller computer 218 by communication line 201. The seller computer 218 can be also be placed in electronic signal communication with the user purchase request device 220 by communication line 205. The operation of the seller computer 218 in the overall apparatus 200 will be described further below.

The user purchase request device 220 (FIG. 6) of the prize issuing apparatus 200 can be any device which is configured to receive and forward a request for a purchase from a user to a credit entity. (It is to be reminded that the use of the term “credit entity” is being used generically to refer to any entity which ensures payment for a purchase, including debit entities and payment processing entities. This also applies to the term “credit account”, which is also intended to include the use of a debit account or a purchase account which is under the ultimate control of the user making a purchase request.) Examples of the user purchase request device 220 can include the following (without by way of limitation): (i) a scanner for scanning electronically encoded information from a credit (or debit) card; (ii) a keypad whereby user credit account information can be entered; and (iii) a remote computer under the control of the user. In general, the user purchase request device 220 is used to provide user purchase request information to the prize activity host computer 210 (either directly via communication link 203, or indirectly through the seller computer 218 via communication links 205 and 201). The purchase request information can include information such as user account number, user identification, seller identification, and purchase request amount. The user purchase request device 220 can also include a user verification parameter input device 223, such as a keypad for receiving a personal identification number, or a biometric scanner (e.g., fingerprint or iris scanner). (The use of verification parameters was described above.) While not a part of the apparatus 200 itself, the apparatus can be configured to work with a credit card 222 (or a similar type card, such as a debit card or smart card). Specifically, if the credit card 222 includes encoded readable information (such as via a magnetic strip or optically encoded information), then the user purchase request device 220 can be configured to read this information from the card 222 and transmit the information to the prize activity host computer 210.

The apparatus 200 can operate as per the following example (although it will be appreciated that the apparatus 200 can be operated in different ways to achieve the same general result, i.e., of issuing a prize to a user). A user desiring to make a credit purchase from a seller provides user information, including credit account number information and user identification information. This information can be received from the user via the user purchase request device 220. Optionally, the user can also provide a user verification parameter via user verification parameter input device 223. The user information can be transmitted to the prize activity host computer 210 from the user purchase request device 220 either directly via communication line 203, or indirectly via the seller computer 218 and communication lines 205 and 201. The seller computer 218 transmits a purchase authorization request to the prize activity host computer 210, including information such as the seller identification and the amount of the purchase being requested. Upon receipt of the user identification and the purchase authorization request, the prize activity host computer 210 makes a determination as to whether or not the purchase request will be authorized. This can include comparing any user verification parameter against a parameter on file for the indicated user, as well as making other user verification checks. The determination can also include checking the amount of the purchase being requested against available credit for the user. In general, the prize activity host computer 210 is configured to receive the purchase authorization request (and any user information and/or user verification parameters) and to determine a probability of verification of the user (as well as verification that the purchase request is authorized). If the purchase authorization request is denied (including for reasons of non-acceptance of probability of verification of the user), this information is provided by the prize activity host computer 210 to the seller computer 218, and the information can be displayed visually on the seller display device 219. If the purchase request is authorized, then the prize activity host computer 210, under control of the prize issuing program 212, makes a determination as to the kind and/or value of a prize for which the user is eligible (via the prize type/value algorithm 216), and whether or not the prize is to be issued to the user (via the prize probability algorithm 214). (A detailed example of the operation of the prize issuing program 212 was provided above with respect to the flowchart of FIGS. 5A and 5B.) If a prize is to be issued to the user, then the prize activity host computer 210 sends a notification message to this effect to the seller computer, and the message can then be displayed on the seller computer display device 219. The message can include prize information telling a user that they have won a prize, and how the prize may be claimed (if it is not physically given to the user at that time). In certain instances the prize is a cash prize which is instantly credited to the users account, thus achieving a immediate useful, concrete and tangible result. In an alternative arrangement the user purchase request device 220 of FIG. 6 can be replaced with the user computer 320 of FIG. 7, describe below with respect to the system 300.

System for the Essentially Instantaneous Issuing of Prizes to Users Based on Use of a Credit Account to Make a Purchase

Turning now to FIG. 7, an exemplary embodiment of a system 300 for instantaneously issuing prizes to users is depicted by a block diagram. The system 300 issues prizes based on a user's use of a credit account under the control of the user to make a purchase from a seller. The main components of the system 300 include a prize activity host computer 310 (similar to the prize activity host computer 210 of FIG. 6 and described above), a seller computer 318 (similar to the seller computer 218 of FIG. 6 and described above), and a user computer 320. The prize activity host computer 310 can include a prize issuing program, which can be similar to the prize issuing program of FIGS. 5A and 5B, as well as the prize issuing program 212 described above with respect to FIG. 6. The system 300 is particularly useful in allowing a user to make an online purchase, such as from a seller having an internet website (hosted by the seller computer 318). The prize activity host computer 310 and the seller computer 318 can be placed in electronic signal communication with one another via communication line 301. The seller computer 318 and the user computer 320 can be placed in electronic signal communication with one another via communication line 301. Likewise, the prize activity host computer 310 and the user computer 320 can be placed in electronic signal communication with one another via communication line 303. Communication lines 301, 303 and 305 can be any currently known or future means of communicating information (and particularly information in a digital format), including wireless communication (e.g., by cell phone lines, satellite communication, radio frequency communication, etc.), as well as wired communication (e.g., landlines, fiber optic cables, dedicated hard-wired communication systems, etc.). The seller computer 320 can include a display device 324 (such as a video screen) and an input device 322. The seller computer input device 322 can include a keyboard, as well as a touch screen, a magnetic card reader, an optical card reader, and a biometric parameter reader. The system 300 can further include a prize inventory account 332 (which is an account funded by (or on behalf of) the prize activity host) and a user account 334 (which is an account recording credits and debits of the user). The system 300 can further include a user credit card (222, FIG. 6), user debit card, or a user smart card 10 (FIGS. 1-4).

In one variation of the system 300 of FIG. 7 the user computer 320 can be a smart card (e.g., smart card 10 of FIGS. 1-4). In this instance the user computer display device 324 of FIG. 7 can be the smart card display device 60 (or at least the screen portion 60, FIGS. 1 and 3) of the smart card 10. Likewise, the user computer input device 322 of the user computer 320 can be the smart card input device 30 (FIGS. 1 and 3). In the instance where the user computer 320 of the system 300 is a smart card (e.g., smart card 10, FIGS. 1-4), then an intermediate user purchase request device (such as item 220 of FIG. 6, which can be a smart card reader) can be interposed in communication line 303 and/or 305 to allow information to be communicated to and/or from the smart card to the (respective) prize activity host computer 310 (FIG. 7) and/or the seller computer 318.

One example of the operation of the system 300 will now be described. It will be appreciated, however, that the system 300 can be operated in other ways, all within the spirit of the instant disclosure. In the example, a user uses the user computer 320 to contact the seller computer 318 (e.g., to access a seller website via the internet). The user then selects a product or service offered by the seller and indicates a desire to purchase the product or service. The seller computer 318 then prompts the user (via communication to the user computer 320, and specifically to the user display 324) to provide purchase request information, including user information (e.g., identify of the user, and shipping address and billing address), as well as payment information (e.g., user account information). The user then responds by providing the requested information via the user input device 322. The seller computer 318 at this time also generates a purchase authorization request, requesting the prize activity host computer 310 to authorize the purchase. The purchase authorization request can include not only the amount of the purchase requested, but also information as to the type of goods or services being purchased. At this point, the user purchase request information and the purchase authorization request are forwarded to the prize activity host computer 310. (The prize activity host computer 310 processes purchase requests, as well as provides prize information.) The forwarding (or communication) of the user purchase request information can be forwarded to the prize activity host computer 310 in at least three distinct ways, as follows. First, all of the user purchase request information (i.e., user information and payment information) can be forwarded directly to the prize activity host computer 310 from the user computer 320 via communication line 303. Second, all of the user purchase request information (i.e., user information and payment information) can be forwarded indirectly to the prize activity host computer 310 from the user computer 320 via the seller computer 318 through communication lines 305 and 301. Third, the user purchase request information (i.e., user information and payment information) can be parsed among the seller computer 318 and the user computer 320 for transmission to the prize activity host computer 310. (When user purchase request information is communicated indirectly to the prize activity host computer 310, it can be encoded with a unique transaction identifier to allow the prize activity host computer 310 to match component parts of a purchase request.) The forwarding of the purchase authorization request from the seller computer 318 to the prize activity host computer 310 is typically communicated directly via communication line 301, but can also be done indirectly via the seller computer and communication lines 305 and 303.

The communication of the purchase request information to the prize activity host computer 310 can also include communication (i.e., transmitting) one or more user verification parameters from the user computer 320 to the prize activity host computer 310. This can be done directly (via communication line 303) or indirectly through the seller computer 318 and communication lines 305 and 301.

Once the prize activity host computer 310 receives all of the purchase request information (i.e., purchase authorization request information and user information, as well as any user verification parameter), the prize activity host computer 310 then processes the information to determine if (i) the user is verified (based on user purchase request information, as well as any user verification parameter), and (ii) the purchase is authorized (e.g., if the user account 334 can sustain a charge of the amount indicated in the purchase authorization request). If the prize activity host computer 310 determines that the user is verified, and the purchase request is authorized, then the prize activity host computer 310 notifies the user computer 320 (and also potentially the seller computer 318) by way of requesting confirmation from the user to complete the purchase transaction. If the user confirms the purchase (from the user computer 320, via input device 322), then a purchase confirmation message is sent to the prize activity host computer 310 from the user computer 320 (or the seller computer 318). Once the prize activity host computer 310 receives confirmation that a purchase has been made by the user using the user account 334, then the prize activity host computer 310 uses the prize issuing program 312 to determine if a prize is to be issued to the user based on the instant purchase just made by the user. (Examples of the operation of the prize issuing program 312 have been previously provided herein, as indicated above, and particularly with respect to FIGS. 5A and 5B and the accompanying description.) If the prize issuing program 312 determines that a prize is to be issued to the user (based on the current purchase activity being transacted by the user and using the user account 334), then a prize communication (message) is sent to the user informing the user that a prize has been issued to the user. The prize communication includes prize information notifying the user of (i) the type and/or value of the prize won by (i.e., issued to) the user, and (ii) any information required in order for the user to claim the prize.

Once a prize has been issued, or designated for issue, to a user (as described above), then the prize can be debited from the prize inventory account 332. If the prize is a cash prize, then the cash prize can be immediately credited to the user account 334. The prizes offered and issued under the prize activity are real, and are thus concrete and tangible at a certain stage. For example, a cash prize and a seller credit prize are concrete and tangible prizes in that they both constitute the equivalent of cash-in-hand to the user to whom the prize has been issued.

Method for Issuing Prizes to Users Based on their Use of a Credit Account

One or more methods for issuing prizes to users based on their use of a credit account (or debit account or the like) to make a purchase have been described herein, and particularly with respect to (i) the method of operation of the apparatus 200 of FIG. 6, and (ii) the method of operation of the system 300 of FIG. 7. The methods further include all of the alternative arrangements described and disclosed herein above.

General Remarks

It will be appreciated that the prize activity disclosed and described herein may be subject to local laws in its implementation, which may place restrains on certain of the apparatus, system and methods described herein. However, the above disclosure is not intended to be limited by local laws, but is rather intended to describe all possible implementations.

It will be further appreciated that the apparatus, systems and methods described above achieve an immediate useful, concrete and tangible result by way of issuing prizes to users in a substantially instantaneous manner (i.e., prizes are generally issued contemporaneously following a purchase request being authorized (and the purchase being consummated), and a determination being made that a prize is to be issued to the user based on the instant purchase being made). The prizes are (after being claimed by the user, if not actually at the time of being issued) concrete and tangible in nature. This includes the possibility of a user being eligible for a later drawing for a grand prize since some user will, in the end, be the recipient of the grand prize. The above disclosure is premised on (but not necessitated by) all available prizes (or at least a significant portion thereof) ultimately being issued to users.

It is to be understood that the totality of the disclosure provided above can be combined in numerous different ways in order to provide for various different apparatus, systems and methods, all of which can be properly claimed as part of the above disclosure.

I claim:

1. An apparatus comprising:
a prize activity host computer including a prize issuing program;
a seller computer including a seller display device; and
a user purchase request device;
and wherein:
the prize issuing program comprises a prize probability algorithm and a prize type/value algorithm;
the seller computer is in signal communication with the prize activity host computer and the user purchase request device;
the seller computer is configured to transmit a purchase authorization request to the prize activity host computer, the purchase authorization request including purchase information including a purchase amount;
the user purchase request device is configured to transmit to the prize activity host computer user information, including user identification information and user account information relating to a user account held by a user; and
the prize activity host computer is configured to:
receive the purchase authorization request and the user information, and to authorize the purchase upon verification of the user information and determining that the user account is authorized to receive a charge for the purchase amount;
upon authorizing the purchase, to determine at least one of the type or value of a prize for which the user is eligible using the prize type/value algorithm, and thereafter to determine that the prize is to be issued to the user using the prize probability algorithm;
to send a notification to the user that the prize has been issued to the user; and
to issue the prize to the user.

2. The apparatus of claim 1 and further wherein:
the user purchase request device is in signal communication with the prize activity host computer; and
the user information is sent directly from the user purchase request device to the prize activity host computer.

3. The apparatus of claim 1 and wherein the user purchase request device is a credit card scanner configured to scan a credit card and to obtain the user information therefrom.

4. The apparatus of claim 1 and further comprising a user verification parameter input device configured to receive a user verification parameter from the user, and wherein:
the user verification parameter is transmitted to the prize activity host computer; and
the prize activity host computer uses the user verification parameter to authorize the purchase.

5. The apparatus of claim 4 and wherein the verification parameter input device is one of a keypad configured to receive a personal identification number, or a biometric sensor configured to receive a biometric input from the user.

6. The apparatus of claim 1 and wherein the prize type/value algorithm is configured to determine the prize to be issued to the user based on prior purchases made by the user via the user account over a defined time period.

7. The apparatus of claim 1 and wherein the prize probability algorithm is configured to increase a probability that the prize will be issued to the user based on prior purchases made by the user via the user account over a defined time period.

8. The apparatus of claim 1 and wherein the notification to the user that the prize has been issued is sent to the user seller computer for display on the seller display device.

9. The apparatus of claim 1 and wherein the notification to the user that the prize has been issued is sent to the user within 30 seconds or less of the purchase authorization request being authorized by the prize activity host computer.

10. A system comprising:
a prize activity host computer including a prize issuing program;
a seller computer; and
a user computer;
and wherein:
the prize activity host computer is in signal communication with the seller computer and the user computer;
one of the seller computer or the user computer is configured to transmit a purchase authorization request to the prize activity host computer, the purchase authorization request including purchase information including a purchase amount;
one of the seller computer or the user computer is configured to transmit to the prize activity host computer user information, including user identification information and user account information relating to a user account held by a user;
the prize activity host computer has access to the user account and to a prize inventory account; and
the prize activity host computer is configured to:
receive the purchase authorization request and the user information, and to authorize the purchase upon verification of the user information and determining that the user account is authorized to receive a charge for the purchase amount;
upon authorizing the purchase, to determine a prize to be issued to the user using the prize issuing program;
to send a notification to the user that the prize has been issued to the user;
to issue the prize to the user; and
to debit the prize from the prize inventory account.

11. The system of claim 10 and further wherein the user computer has a user display device, and the notification that the prize has been issued to the user is displayed on the user display device.

12. The system of claim 11 and wherein the user computer is a smart card which includes a computer readable memory device including the user information, the system further comprising a user purchase request device configured to transmit the user information from the smart card to one of the prize activity host computer or the seller computer the user information.

13. The system of claim 10 and further comprising a smart card, and wherein the smart card is configured to transmit to one of the prize activity host computer, the seller computer or the user computer user authentication information to verify identify of the user.

14. The system of claim 10 and wherein the notification that the prize has been issued to the user is sent to the user within thirty seconds of authorizing the purchase.

15. The system of claim 10 and wherein the user computer includes a user input device configured to receive a user verification parameter, and the prize activity host computer is further configured to ascertain if the received user verification parameter corresponds to previously received user verification information corresponding to the user information, and to base the determination of approving the purchase request on the same.

16. A method to issue a prize to a user of a credit account based on the user making a purchase using the credit account, the method comprising:
receiving a purchase authorization request based on the user requesting a purchase to be authorized and charged against the credit account, the purchase authorization request including purchase information including the amount of the purchase for which authorization is requested;
receiving user information, including user identification information and user account information;
using the user information and the purchase information to authorize the purchase request;
upon authorizing the purchase request, determining the prize to be issued to the user; and
issuing the prize to the user.

17. The method of claim 16 and wherein determining the prize to be issued to the user comprises using information regarding past purchases made by the user using the user account.

18. The method of claim 16 and wherein the prize is issued within 30 seconds of the purchase request being authorized.

19. The method of claim 16 and wherein the purchase authorization request is sent from a seller from which the purchase is being made.

20. The method of claim 16 and wherein the purchase authorization request is sent from the user.

21. The method of claim 16 and wherein the purchase is being made from a seller, the credit account is hosted by a credit entity, and the prize is provided through a collaboration of the credit entity and the seller.

22. The method of claim 16 and wherein the credit account is hosted by a credit entity, and the prize is provided by the credit entity.
